(19) United States
(12) Patent Application Publication
(10) Pub. No.: US 2003/0166485 A1
(43) Pub. Date: Sep. 4, 2003

(54) Bleach catalyst enhancement

(75) Inventors: Ronald Hage, Vlaardingen (NL); Jan Klugkist, Vlaardingen (NL); Ton Swarthoff, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/375,235

(22) Filed: Feb. 27, 2003

(30) Foreign Application Priority Data
Feb. 28, 2002 (GB) 0204824.7
May 31, 2002 (GB) 0212751.2

(51) Int. Cl. C11D 7/18

(52) U.S. Cl. 510/314

(57) ABSTRACT

The invention relates to catalytically bleaching substrates, especially laundry fabrics, with a bleaching catalyst in the presence of an enzymatic bleach enhancing system.

### FIELD OF INVENTION

The present invention relates to enhancing the activity of a bleaching catalyst.

### BACKGROUND OF INVENTION

WO 93/19811 discloses the use of lipoxygenase, linoleic acid and metal complexes with ambient oxygen to degrade an environmental contaminant.

DK 0352/98 discloses a process for bleaching coloured stains, comprising contacting, in an aqueous solution, the stain with a lipoxygenase enzyme, an unsaturated fatty acid and a transition metal ion.

The use of bleaching catalysts for stain removal has been developed over recent years. The recent discovery that some catalysts are capable of bleaching effectively with air has recently become the focus of some interest, for example, GB applications: 9906474.3; 9907714.1; and 9907713.3 (all Unilever). As with any cleaning product a more economical use of active components and effective stain bleaching profile is sought.

### SUMMARY OF INVENTION

The bleaching of a stain by a peroxyl species is aided by the presence of an active transition metal catalyst. A peroxyl species commonly found in laundry bleaching compositions is hydrogen peroxide (H₂O₂) or a precursor thereof, e.g., sodium percarbonate or sodium perborate. In many instances an activator/precursor, e.g., TAED (tetraacetylethylene diamine), is present which serves together with hydrogen peroxide to form a peracid [RC(O)OOH] to facilitate bleaching.

Recently we have found that oily stains are bleached in the presence of selected transition metal catalysts in the absence of an added peroxyl source. The bleaching of an oily stain in the absence of an added peroxyl source has been attributed to oxygen derived from the air. Whilst it is true that bleaching is effected by oxygen sourced from the air the route in which oxygen plays a part is becoming understood. In this regard, the term “air bleaching” and “air mode” are used.

We have concluded from our research that bleaching of a chromophore in an oily stain is effected by products formed by adventitious oxidation of components in the oily stain. These products, alkyl hydroperoxides, are generated naturally by autoxidation of the oily stain and the alkyl hydroperoxides together with a transition metal catalyst serve to bleach chromophores in the oily stain. Alkyl hydroperoxides (ROOH) are generally less reactive that other peroxy species, for example, peracids (RC(O)OOH), hydrogen peroxide (H2O2), percarbonates and perborates.

We have found that there is a synergistic interaction between air bleaching catalysts and an enzyme system for generating hydroperoxides in bleaching stains. The enzyme system for generating hydroperoxides may be used in bleaching a substrate with a transition metal catalyst in either a “peroxyl mode” or an “air mode”.

In an “air mode” bleaching is effected by oxygen sourced from the air and a hydroperoxide that enzymatically generated in the wash. In a “peroxyl mode” bleaching is effected by peroxyl present in the bleaching composition and a hydroperoxide that is enzymatically generated in the wash.

The present invention provides a bleaching composition comprising an organic ligand which forms a complex with a transition metal for bleaching a substrate with atmospheric oxygen, the bleaching composition upon addition to an aqueous medium providing an aqueous bleaching medium substantially devoid of peroxygen bleach or a peroxy-based or peroxyl-generating bleach system, together with an oxidizable precursor selected from the group consisting of:

(i) an unsaturated acid or alkali metal salt thereof; and (ii) a generating system for producing an unsaturated acid in situ in an aqueous medium,

together with an enzyme for oxidising the oxidizable precursor to form a hydroperoxide in situ.

In order to permit differentiation of components, within the context of the present invention as claimed, neither the organic ligand or transition metal complex thereof nor the enzyme system for generating hydroperoxides should be construed as a peroxygen bleach or source thereof. In addition, the organic ligand which forms a complex with a transition metal is additional and distinct from other components.

The bleaching composition of the present invention provides for the lipase hydrolysis of an unsaturated oil (triglyceride) to provide an unsaturated carboxylic acid (or soap formed therefrom) which is subsequently oxidized by a lipoxygenase to form a hydroperoxide which together with a catalyst serves to bleach a stain. Alternatively, the bleaching composition comprises an unsaturated carboxylic acid (or soap formed therefrom) which obviates the lipase hydrolysis step described above. In some instances unsaturated oils in a stain serve as a precursor for the lipoxygenase to provide a hydroperoxide intimate with the stain.

The greatest effect is provided by a bleaching composition comprising a catalyst, a lipase and a lipoxygenase together with metabolites or precursors thereof for the enzyme system (lipase and lipoxygenase).

The present invention has particular utility as a bleaching composition in a commercial “air bleaching” liquid and granular “air bleaching” or peroxyl bleaching format.

The composition of the present invention, in an air bleaching mode, is preferably substantially devoid of a delibrately added peroxygen bleach or a peroxy-based or peroxyl-generating bleach system. The term “substantially devoid of a peroxygen bleach or a peroxy-based or peroxyl-generating bleach system” should be construed within spirit of the invention. It is preferred that the composition has as low a content of a peroxyl species present as possible. Nevertheless, autoxidation is something that is very difficult to avoid and as a result small levels of peroxyl species may be present. These small levels may be as high as 2% but are preferably below 2%. The level of peroxide present is expressed in mMol of hydroperoxide (—OOH) present per Kg. Optionally added organic compounds having labile CH's, for example allylic, benzylic, —C(O)H, and —CRH—O—R′, are particularly susceptible to autoxidation and hence may contribute more to this level of peroxyl species than other components. However the presence of an antioxidant in the composition will likely serve to reduce the presence of adventitious peroxyl species by reducing chain reactions. With regard to the surfactant used it is preferred the total surfactant contribution having a HLB greater than 10 has a hydroperoxide content (HPO) of less than 100 mMol/Kg, preferably less than 50 mMol/Kg, most preferably less than 15 mMol/kg.

At least 10% of any bleaching of the substrate is effected by oxygen sourced from the air when the composition is for use in an air bleaching mode. In the “air bleaching mode” preferably at least 50% and optimally at least 90% of any bleaching of the substrate being effected by oxygen sourced from the air. The present invention may function with the presence of small amounts of peroxide, e.g., sodium percarbonate or sodium perborate; in this regard the bleaching composition contains less than 2% wt/wt of an peroxy-based or peroxyl-generating bleach system, more preferably less than 1% wt/wt, and most preferably less than 0.5% wt/wt.

The present invention extends to a commercial package comprising the bleaching composition according to the present invention together with instructions for its use.

Any suitable textile that is susceptible to bleaching or one that one might wish to subject to bleaching may be used. Preferably the textile is a laundry fabric or garment.

In a preferred embodiment, the method according to the present invention is carried out on a laundry fabric using an aqueous treatment liquor. In particular, the treatment may be effected in a wash cycle for cleaning laundry. More preferably, the treatment is carried out in an aqueous detergent bleach wash liquid, preferably in a washing machine.

A unit dose as used herein is a particular amount of the bleaching composition used for a type of wash. The unit dose may be in the form of a defined volume of powder, granules or tablet or unit dose detergent liquid.

### DETAILED DESCRIPTION OF THE INVENTION

Bleach Catalyst

The bleach catalyst per se may be selected from a wide range of organic molecules (ligands) and complexes thereof. Suitable organic molecules (ligands) and complexes for use with the present invention are found, for example in:

GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and WO0060045 the complexes and organic molecule (ligand) precursors of which are herein incorporated by reference. The air bleaching catalysts as used herein should not be construed as an peroxyl-generating system, alone or in combination with other substrates, irrespective of how they bleaching action works.

Another example of an air bleaching catalyst is a ligand or transition metal catalyst thereof of a ligand having the formula (I):

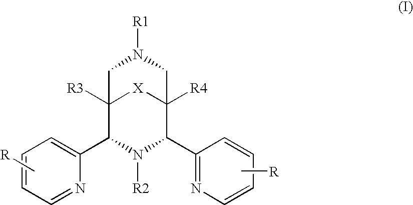

wherein each R is independently selected from: hydrogen, hydroxyl, and C1-C4-alkyl;

R1 and R2 are independently selected from:

C1-C4-alkyl,

C6-C1O-aryl, and,

a group containing a heteroatom capable of coordinating to a transition metal, wherein at least one of R1 and R2 is the group containing the heteroatom;

R3 and R4 are independently selected from hydrogen, C1-C8 alkyl, C1-C8-alkyl-O-C1-C8-alkyl, C1-C8-alkyl-O-C6-C1O-aryl, C6-C10-aryl, C1-C8-hydroxyalkyl, and —(CH2)ₙC(O)OR5 wherein R5 is C1-C4-alkyl, n is from 0 to 4, and mixtures thereof; and,

X is selected from C=O, —[C(R6)₂]_{y}— wherein Y is from 0 to 3 each R6 is independently selected from hydrogen, hydroxyl, C1-C4-alkoxy and C1-C4-alkyl.

It is preferred that the group containing the hetroatom is:

a heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; tetrahydropyranyl; and oxazolidinyl, wherein the heterocycloalkyl may be connected to the ligand via any atom in the ring of the selected heterocycloalkyl,

a —C1-C6-alkyl-heterocycloalkyl, wherein the heterocycloalkyl of the —C1-C6-heterocycloalkyl is selected from the group consisting of: piperidinyl; piperidine; 1,4-piperazine,tetrahydrothiophene; tetrahydrofuran; pyrrolidine; and tetrahydropyran, wherein the heterocycloalkyl may be connected to the —C1-C6-alkyl via any atom in the ring of the selected heterocycloalkyl,

a —C1-C6-alkyl-heteroaryl, wherein the heteroaryl of the —C1-C6-alkylheteroaryl is selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; beinzimidazolyl; thiazolyl; oxazolidinyl; pyrrolyl; carbazolyl; indolyl; and isoindolyl, wherein the heteroaryl may be connected to the —C1-C6-alkyl via any atom in the ring of the selected heteroaryl and the selected heteroaryl is optionally substituted by —C1-C4-alkyl,

a —C0-C6-alkyl-phenol or thiophenol,

a —C2-C4-alkyl-thiol, thioether or alcohol,

a —C2-C4-alkyl-amine, and

a —C2-C4-alkyl-carboxylate.

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The transition metal complex preferably is of the general formula (AI):

[MₐLₖXₙ]Yₘ

in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

It is preferred that the organic molecule (ligand) or transition metal complex is present in the composition such that a unit dose provides at least 0.1 μM of the organic molecule or transition metal complex thereof.

The transition metal complex may be preformed or formed in situ. The organic substance (ligand) required has complexing qualities. The ligand may be present in the bleaching composition as a free ligand or the complex formed in situ, for example, in tap water used to wash cloths or stain. Ligands have different binding constants for different transition metals and tap water usually contains many different transition metal ions. A transition metal complex may be used in the method of the present invention that is not itself active in bleaching with atmospheric oxygen. However, upon addition to tap water an active atmospheric oxygen bleaching solution is formed. Common transition metals found in tap water at a relatively high concentration are iron and manganese ions. A different transition metal complex may be formed in situ than found in the bleaching composition used. The formation of a particular type of transition metal complex other than the transition metal complex found in the bleaching composition is dependent on the binding constant for a particular transition metal, transition metal ions present tap water and the concentration of transition metal ions present in the tap water. In addition, not only may the ligand complex with transition metals present in the bleaching medium but with transition metals found in a stain; for example tomato oil stains have relatively high concentrations of transition metals present, in particular iron. Alternatively, the ligand may complex with manganese as found in tea stains. However, it is preferred that the bleaching composition comprises a preformed iron transition metal catalyst.

The present invention may be used in a peroxyl bleaching mode in contrast to an air bleaching mode in which the composition is substantially devoid of a peroxyl source. However it is preferred to use the present invention in an air bleaching mode. If the invention is to be used in a peroxyl bleaching mode, in this instance a purely peroxyl bleaching catalyst may be employed in contrast to an “air bleaching” catalyst.

The Lipoxygenase Enzyme

The enzymatic detergent compositions of the invention comprise 5,000-1,000,000 units of a lipoxygenase per gram of detergent composition, preferably 5,000-600,000 units of a lipoxygenase per gram of detergent composition and even more preferably 8,000-125,000 units op a lipoxygenase per gram of detergent composition. In which one unit will cause an increase in A234 of 0.001 per min at pH 9.0 at 25° C. when linoleic acid is the substrate in 3.0 ml volume (1 cm light path). One A234 unit is equivalent to the oxidation of 0.12 μmole of linoleic acid. The soybean enzyme will use arachidonic acid as substrate, with approximately 15% of the activity indicated using linoleic acid as substrate; the product of arachidonic acid oxidation is 12- or 15-hydroperoxyarachidonic acid (12-HETE or 15-HETE). More details are given in the following references: 1) Doderer, A., et al., Biochim. Biophys. Acta, 1120, 97 (1992). 2) van Os, C. P. A., Biochim. Biophys. Acta, 663, 177 (1981). 3) Rashbrook, L. C., et al., Biochem Soc. Trans., 13, 233 (1985).

Suitable enzyme lipoxygenases for the compositions of the invention can be found in the enzyme classes of the lipoxygenases, enzyme class 1.13.11.* where * is preferably 12 or 13.

Examples of suitable enzymes are: Lipoxygenase (EC 1.13.11.12), Arachidonate 5-lipoxygenase (EC 1.13.11.34), Arachidonate 12-lipoxygenase (EC 1.13.11.31), and Arachidonate 15-lipoxygenase (EC 1.13.11.33), Lipoxygenase (EC 1.13.11.12) is the preferred enzyme.

The Lipolytic Enzyme

As a second constituent, the enzymatic detergent compositions of the invention preferably comprise 10-20,000 LU per gram, and more preferably 50-2,000 LU per gram and even more preferably 80-500 LU per gram of the detergent composition of a lipolytic enzyme selected from the group consisting of Lipolase, Lipolase ultra, LipoPrime, Lipex, Lipomax, Liposam, and lipase from Rhizomucor miehei (e.g. as described in EP-A-238 023 (Novo Nordisk).

In this specification LU or lipase units are defined as they are in EP-A-258 068 (Novo Nordisk).

Suitable enzymes for the compositions of the invention can be found in the enzyme classes of the esterases and lipases, (EC 3.1.1.*, wherein the asterisk denotes any number).

A characteristic feature of lipases is that they exhibit interfacial activation. This means that the enzyme activity is much higher on a substrate which has formed interfaces or micelles, than on fully dissolved substrate. Interface activation is reflected in a sudden increase in lipolytic activity when the substrate concentration is raised above the critical micel concentration (CMC) of the substrate, and interfaces are formed. Experimentally this phenomenon can be observed as a discontinuity in the graph of enzyme activity versus substrate concentration. Contrary to lipases, however, cutinases do not exhibit any substantial interfacial activation.

Because of this characteristic feature, i.e. the absence of interfacial activation, we define for the purpose of this patent application Cutinases as lipolytic enzymes which exhibit substantially no interfacial activation. Cutinases therefor differ from classical lipases in that they do not possess a helical lid covering the catalytic binding site. Cutinases belong to a different subclass of enzymes (EC 3.1.1.50) and are regarded to be outside the scope of the present invention.

Of main interest for the present invention are fungal lipases, such as those from Humicola lanuginosa and Rhizomucor miehei. Particularly suitable for the present invention is the lipase from Humicola lanuginosa strain DSM 4109, which is described in EP-A-305 216 (Novo Nordisk), and which is commercially available as Lipolase (TM). Also suitable ar variants of this enzyme, such as described in WO-A-92/05249, WO-A-94/25577, WO-A-95/22615, WO-A-97/04079, WO-A-97/07202, WO-A-99/42566, WO-A-00/60063. Especially preferred is the variant D96L which is commercially available from Novozymes as Lipolase ultra, and the variant which is sold by Novozymes under the trade name LipoPrime. Another preferred variant is T231R+N233R which is commercially available from Novozymes as Lipex. The lipolytic enzyme of the present invention can usefully be added to the detergent composition in any suitable form, i.e. the form of a granular composition, a slurry of the enzyme, or with carrier material (e.g. as in EP-A-258 068 and the Savinase (TM) and Lipolase (TM) products of Novozymes). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

The enzyme to be used in the detergent compositions according to the invention can be produced by cloning the gene for the enzyme into a suitable production organism, such as Bacilli, or Pseudomonaceae, yeasts, such as Saccharomyces, Kluyveromyces, Hansenula or Pichia, or fungi like Aspergillus. The preferred production organism is Aspergillus with especial preference for Aspergillus oryzae.

When both lipase and lipoxygenase are present in the bleaching composition of the present invention it is preferred that the ratio of lipase:lipoxygenase is in the weight ratio range from 1:10 to 10:1.

The Detergent Composition

The air bleach catalyst and unsaturated organic compound may be used in a detergent composition specifically suited for stain bleaching purposes, and this constitutes a second aspect of the invention. To that extent, the composition comprises a surfactant and optionally other conventional detergent ingredients. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

It is preferred that the bleaching composition comprises at least 1% an unsaturated surfactant, preferably an anionic surfactant having an HLB of at least 10. The detergent composition may take any suitable physical form, such as a powder, granular composition, tablets, a paste or an anhydrous gel.

Enzymes

The detergent compositions of the present invention may additionally comprise one or more other enzymes, which provide cleaning performance, fabric care and/or sanitation benefits.

Said enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press.

The composition may contain additional enzymes as found in WO 01/00768 A1 page 15, line 25 to page 19, line 29, the contents of which are herein incorporated by reference.

The composition may also contain antioxidants or reductants as taught in WO 00/521124.

Builders, polymers and other enzymes as optional ingredients may also be present as found in WO0060045.

Suitable detergency builders as optional ingredients may also be present as found in WO0034427.

The composition of the present invention may be used for laundry cleaning, hard surface cleaning (including cleaning of lavatories, kitchen work surfaces, floors, mechanical ware washing etc.). As is generally known in the art, bleaching compositions are also employed in waste-water treatment, pulp bleaching during the manufacture of paper, leather manufacture, dye transfer inhibition, food processing, starch bleaching, sterilisation, whitening in oral hygiene preparations and/or contact lens disinfection.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

In a preferred aspect of the present invention the bleaching composition is substantially devoid of fat other than a fat which participates as a precursor for a lipase or a lipoxogenase. By having a low concentration of fat which does not participate in the enzymatic process permits fat which participates in enzymic reactions to be selectively partitioned into an oily stain of a textile, thus aiding the bleaching process by targeting a stain.

The invention will now be further illustrated by way of the following non-limiting examples:

Complex 1

Synthesis of [(MeN4Py)FeCl]Cl

The ligand N,N-bis(pyridin-2-yl-methyl)-1,1-bis(pyridin-2-yl)-1-aminoethane (MeN4py) was prepared as described in EP 0 909 809 A2. The synthesis of the iron complex, [(MeN4Py)FeCl]Cl, has been described elsewhere (WO 0116271).

Detergent formulation A

| | |
|---|---|
| STP: | 0.756 g |
| Na2CO3: | 0.301 g |
| Disilicate: | 0.245 g |
| Na2SO4: | 0.518 g |
| LAS: | 0.420 g |
| NI 7E0: | 0.182 g |

Detergent formulation A was added to one litre of water.

Test cotton cloth samples were treated according to procedure 1 described below. After the wash, the cloths were rinsed with water and subsequently dried at 37° C. and the change in colour was measured 2 hours after drying with a Linotype-Hell scanner (ex Linotype). The change in colour (including bleaching) is expressed as the AE value. The measured colour difference (AE) between the washed cloth and the unwashed cloth is defined as follows:

ΔE=[(ΔL)²+(Δa)²+(Δb)²]^{1/2}

wherein ΔL is a measure for the difference in darkness between the washed and unwashed test cloth; Δa and Δb are measures for the difference in redness and yellowness respectively between both cloths. With regard to this colour measurement technique, reference is made to Commission International de 1'Eclairage (CIE); Recommendation on Uniform Colour Spaces, colour difference equations, psychometric colour terms, supplement no 2 to CIE Publication, no 15, Colorometry, Bureau Central de la CIE, Paris 1978. The results are shown in the tables below. A higher value indicates a better performance. The values as given as statistically significant for values of 1 ΔE or greater.

Procedure 1 A cloth stained with one of curry oil, tomato oil or tomato extract were stirred (cloth to liquor ratio of 1:40 wt/wt) in an aqueous solution of 10 mM Tris-Cl buffer pH 8, 4° FH at a temperature of 25° C. for 30 minutes. After the 30 minutes had passed the aqueous phase was discarded and replaced by, an aqueous solution of detergent A described above, providing an aqueous solution of pH 9, 8° FH, after which the mixture was stirred for a further 30 minutes at 25° C.

Lipolase was added as mg/l of Lipolase 100T granules with an activity of 111 LU/mg granules. Lipoxygenase was added as mg/l solids of Sigma enzyme L7395, which is a soybean lipoxygenase with an activity of 127,000 units/mg solids. The iron complex was added to the wash liquor using a stock solution of 1 mM in water.

Two levels of enzyme and catalyst were employed, as disclosed in the table below. The same amount of enzyme and catalyst was present in the Tris-Cl buffer described in procedure 1.

Results of Experiment with Combination of Lipolase, Lipoxygenase and [(MeN4Py)FeCl]Cl in the Absence of an Added Peroxyl Species

| | | | | Results (delta E vs | | |
|---|---|---|---|---|---|---|
| | Concentration | | | blank) | | |
| | Lipolase | Lipoxygenase | Complex | Curry | Tomato | Tomato |
| Expt. | (mg/l) | (mg/l) | 1 (μM | oil | oil | extract |
| 1 | 10 | 10 | 1.7 | 16.1 | 6.5 | 26.0 |
| 2 | 10 | 10 | | 4.0 | 1.3 | 3.3 |
| 3 | 10 | | 1.7 | 8.7 | 5.8 | 4.6 |
| 4 | | 10 | 1.7 | 8.4 | 0.7 | 27.1 |
| 5 | 10 | | | 0.9 | 0.4 | 1.5 |
| 6 | | 10 | | 1.2 | 0.1 | 7.5 |
| 7 | | | 1.7 | 5.6 | 0.0 | 2.9 |
| 1a | 2 | 2 | 0.33 | 10.9 | 1.4 | 23.5 |
| 2a | 2 | 2 | | 2.9 | 0.5 | 5.3 |
| 3a | 2 | | 0.33 | 3.6 | 0.0 | 2.5 |
| 4a | | 2 | 0.33 | 2.6 | 0.2 | 24.4 |
| 5a | 2 | | | 0.5 | −0.3 | 1.5 |
| 6a | | 2 | | 2.8 | 0.1 | 16.8 |
| 7a | | | 0.33 | 2.5 | 0.0 | 1.4 |

1. A bleaching composition comprising an organic ligand which forms a complex with a transition metal for bleaching a substrate via atmospheric oxygen, the bleaching composition upon addition to an aqueous medium providing an aqueous bleaching medium substantially devoid of peroxygen bleach or a peroxy-based or peroxyl-generating bleach system, together with an oxidizable precursor selected from the group consisting of:
(i) an unsaturated acid or alkali metal salt thereof; and (ii) a generating system for producing an unsaturated acid in situ in an aqueous medium,
together with an enzyme for oxidising the oxidizable precursor to form a hydroperoxide in situ.

2. A bleaching composition according to claim 1 for bleaching a substrate, wherein the generating system for producing an unsaturated acid in situ in an aqueous medium is derived from an oily stain, lipoxygenase and the organic ligand.

3. A bleaching composition according to claim 1, wherein bleaching composition comprises fat which has a degree of unsaturation.

4. A bleaching composition according to claim 1, wherein the oxidizable precursor is selected from the following system (i) an enzyme for enzymatically hydrolysing a fat, (ii) and the fat.

5. A bleaching composition according to claim 4, wherein the enzyme for enzymatically hydrolysing a fat is a lipase selected from the group consisting of Lipolase, Lipolase ultra, LipoPrime, Lipomax, Lipex, Liposam, and lipase from Mucor Miehei.

6. A bleaching composition according to claim 4, wherein the generating system for producing an unsaturated acid in situ in an aqueous medium comprises lipoxygenase and a lipoxygenase metabolic system.

7. A bleaching composition according to claim 5, wherein the lipoxygenase metabolic system comprises a fat and lipase, said fat being metabolised to produce linoleate (linoleic acid) for producing (9Z,11E)-13S-13-hydroperoxyoctadec-9,11-dienoate.

8. A bleaching composition according to claim 1, wherein the bleaching composition is devoid of lipase.

9. A bleaching composition according to claim 1, wherein the bleaching composition comprises 5,000-1,000,000 Lipoxygenase Units per gram detergent formulation.

10. A bleaching composition according to claim 9, wherein the bleaching composition comprises 10-20,000 Lipolase Units per gram detergent formulation.

11. A bleaching composition according to claim 10 or claim 10, wherein the ratio of lipase:lipoxygenase is in the weight ratio range from 1:10 to 10:1.

12. A bleaching composition according to claim 1, wherein the organic ligand is present in the formulation in the form of a preformed complex.

13. A bleaching composition according to claim 1, wherein the organic ligand is present in the formulation in the form of a free ligand.

14. A bleaching composition according to claim 1, wherein the bleaching composition comprises a surfactant.

15. A bleaching composition according to claim 14, wherein the surfactant is saturated.

16. A bleaching composition according to claim 14, wherein the surfactant is unsaturated.

17. A bleaching composition according to any preceding claim 1, wherein the bleaching composition comprises a builder.

18. A bleaching composition comprising:
(i) a transition metal catalyst for bleaching a substrate via atmospheric oxygen;
(ii) 5,000-1,000,000 Lipoxygenase Units per gram of bleaching composition; and,
(iii) 10-20,000 Lipase Units per gram of bleaching composition, wherein
the bleaching composition comprises less than 1% wt/wt of a peroxygen bleach.

19. A process for bleaching a stain comprising the steps of treating a textile with a bleaching composition comprising an organic ligand which forms a complex with a transition metal for bleaching a substrate via atmospheric oxygen, the bleaching composition upon addition to an aqueous medium providing an aqueous bleaching medium substantially devoid of a peroxygen bleach or a peroxy-based or peroxyl-generating bleach system, together with an oxidizable precursor selected from the group consisting of: (i) an unsaturated acid or alkali metal salt thereof, and (ii) a generating system for producing an unsaturated acid in situ in an aqueous medium and an enzyme for oxidising the oxidizable precursor to form a hydroperoxide in situ.
